(19) United States
(12) Patent Application Publication
(10) Pub. No.: US 2019/0061263 A1
(43) Pub. Date: Feb. 28, 2019

(54) COMPONENT FABRICATION WITH DIRECTION-BASED ADAPTIVE DESIGN

(71) Applicant: GM Global Technology Operations LLC, Detroit, MI (US)

(72) Inventors: Zhiwei Cui, Troy, MI (US); Weizhang Simon Xu, Troy, MI (US)

(21) Appl. No.: 15/691,148

(22) Filed: Aug. 30, 2017

(51) Int. Cl. B29C 64/393; B33Y 50/02; B33Y 10/00; B33Y 30/00; B33Y 80/00

(52) U.S. Cl. CPC B29C 64/393; B33Y 50/02; B29L 2031/7172; B33Y 30/00; B33Y 80/00; B33Y 10/00

(57) ABSTRACT

A method for fabricating a component includes receiving a first component design, calculating a plastic strain for a load case, and determining whether the plastic strain meets a target plastic strain for the load case. Responsive to determining that the plastic strain does not meet the target plastic strain for the load case the method includes calculating an elastic strain for the load case, defining a linear strain target as a function of the plastic strain, the target plastic strain, and the elastic strain, optimizing for the minimum mass of the component where a linear strain is less than the linear strain target, and outputting a second component design.

### INTRODUCTION

The subject application relates to fabricating machine components and optimizing the design of objects or machine components for dynamic load cases.

Topology and free-form shape optimization is used to ensure that objects such as machine components meet design specification targets. Some design specification targets include targets for the response or performance of the component when the component is subjected to a dynamic load. For example, plastic strain, nonlinear intrusion, linear stiffness, and vibration frequency responses may each have a design specification target that a component should meet to ensure that the component performs to designed standards.

Previous methods for optimizing components included transforming dynamic loads into equivalent static loads (ESL) and performing multiple iterations of the load analysis and optimization for a single load case.

It is desirable to optimize the design of the components for multiple load cases such that minimal materials in fabrication may be used while meeting the design specification targets for component fabrication.

### SUMMARY

According to an exemplary embodiment, a method for fabricating a component includes receiving a first component design, calculating a plastic strain for a load case, and determining whether the plastic strain meets a target plastic strain for the load case. Responsive to determining that the plastic strain does not meet the target plastic strain for the load case the method includes calculating an elastic strain for the load case, defining a linear strain target as a function of the plastic strain, the target plastic strain, and the elastic strain, optimizing for the minimum mass of the component where a linear strain is less than the linear strain target, and outputting a second component design.

In addition to one or more of the features described herein, or as an alternative, further embodiments include fabricating the component according to the first component design responsive to determining that the plastic strain meets the target plastic strain for the load case.

In addition to one or more of the features described herein, or as an alternative, further embodiments include receiving the second component design calculating a second plastic strain for a load case, determining whether the second plastic strain meets a target plastic strain for the load case, and fabricating the component according to the second component design responsive to determining that the second plastic strain meets the target plastic strain for the load case.

In addition to one or more of the features described herein, or as an alternative, further embodiments include wherein the calculating the plastic strain for the load case includes running a nonlinear model to calculate a nonlinear displacement and the plastic strain.

In addition to one or more of the features described herein, or as an alternative, further embodiments include running a linear model where a linear displacement is equal to a nonlinear displacement, calculating forces applied in the load case where the forces are a product of a stiffness matrix and the linear displacement, and calculating the elastic strain.

In addition to one or more of the features described herein, or as an alternative, further embodiments include wherein the elastic strain is calculated using a linear analysis.

In addition to one or more of the features described herein, or as an alternative, further embodiments include wherein the first component design is a design for a fuel tank component.

In addition to one or more of the features described herein, or as an alternative, further embodiments include wherein the component includes a fuel tank.

According to another exemplary embodiment, a system for fabricating a component includes a processor operative to receive a first component design, calculate a plastic strain for a load case, and determine whether the plastic strain meets a target plastic strain for the load case. Responsive to determining that the plastic strain does not meet the target plastic strain for the load case the processor is further operative to calculate an elastic strain for the load case, define a linear strain target as a function of the plastic strain, the target plastic strain, and the elastic strain, optimize for the minimum mass of the component where a linear strain is less than the linear strain target, and output a second component design.

In addition to one or more of the features described herein, or as an alternative, further embodiments include a fabrication tool operative to fabricate the component according to the first component design responsive to the processor determining that the plastic strain meets the target plastic strain for the load case.

In addition to one or more of the features described herein, or as an alternative, in further embodiments the processor is operative to receive the second component design, calculate a second plastic strain for a load case, determine whether the second plastic strain meets a target plastic strain for the load case, and fabricate the component according to the second component design responsive to determining that the second plastic strain meets the target plastic strain for the load case.

In addition to one or more of the features described herein, or as an alternative, further embodiments include, wherein the calculating the plastic strain for the load case includes running a nonlinear model to calculate a nonlinear displacement and the plastic strain.

In addition to one or more of the features described herein, or as an alternative, in further embodiments the processor is operative to run a linear model where a linear displacement is equal to a nonlinear displacement, calculate forces applied in the load case where the forces are a product of a stiffness matrix and the linear displacement, and calculate the elastic strain.

In addition to one or more of the features described herein, or as an alternative, further embodiments include, wherein the elastic strain is calculated using a linear analysis.

In addition to one or more of the features described herein, or as an alternative, further embodiments include, wherein the first component design is a design for a fuel tank component.

In addition to one or more of the features described herein, or as an alternative, further embodiments include, wherein the component includes a fuel tank.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an exemplary embodiment of a machine component;

FIG. 2 illustrates a processing system that includes a processor that is communicatively connected to a memory, a display, and an input device;

FIGS. 3A and 3B illustrate a block diagram of a method for designing and fabricating a component of a machine; and

FIG. 4 illustrates a block diagram of a fabrication system.

### DETAILED DESCRIPTION

The following description is merely exemplary in nature and is not intended to limit the present disclosure, its application or uses.

Objects such as machine components may be designed using topology optimization to optimize the performance of the components when subjected to a variety of load cases. The component designs are modeled and tested under a variety of load conditions to determine whether the designs meet the test targets. If the design does not meet the test targets, the design is revised and retested until the design meets the test targets.

Once the designed machine components meet the test targets for each load case, the machine components may be fabricated using any suitable method such as, for example, injection molding, stamping, bending, forging, casting, brazing, or welding to fabricate the machine components.

Testing may be performed on the component after fabrication to ensure that the component meets the target specifications.

Previous methods for topology optimization used equivalent static load (ESL) methods that were proficient at solving some nonlinear optimization problems. However, the previous methods had challenges solving a plastic strain optimization problem.

The previous equivalent static loads (ESL) methods solved plastic strain optimization problems by modifying the elastic modulus for each element in the linear model until the linear strain (elastic strain) matched the nonlinear strain (plastic strain). The previous ESL methods were limited to one load case since the elastic modulus value depended on the applied load case.

The advantages of these embodiments are that any number of load cases may be applied when solving the plastic strain optimization problem such that a component design may be optimized for each load case prior to fabricating the component. The resultant optimized components meet or exceed testing targets while reducing the materials used to fabricate the components.

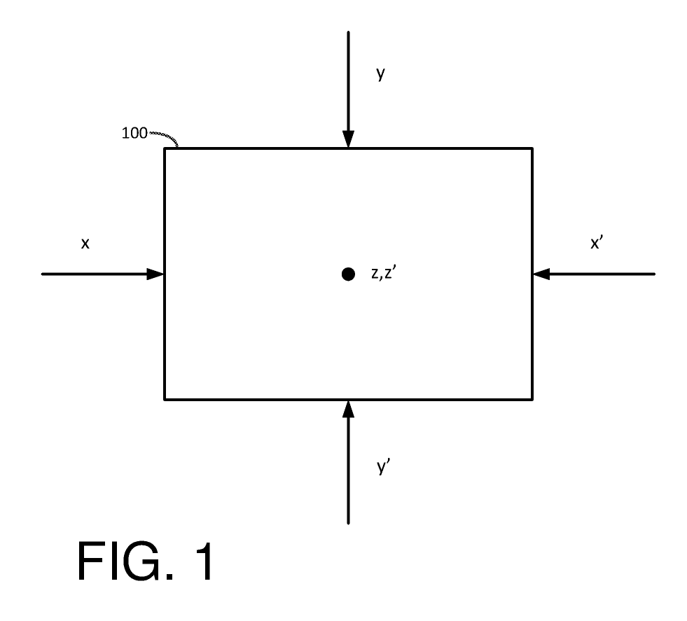

FIG. 1 illustrates an exemplary embodiment of a machine component (component) 100. The machine component 100 may include any type of mechanical component. In the illustrated exemplary embodiment the machine component 100 includes an exemplary fuel tank that should meet a designed target for plastic strain in a variety of load cases, where a load case is a load or force applied in a direction (x, x′, y, y′, z, z′).

A load case may include, for example, a drop test of the component 100 from a particular height such that a designated side of the component 100 lands on a hard surface. The component 100 may be modeled in a computer, and the model may be subjected to the load cases to determine whether the plastic strain meets the targets for each of the load cases. If not, the design of the fuel tank is modified, and the modified model is retested to determine whether the plastic strain meets the targets for each of the load cases.

Previous ESL methods would only allow optimization for one load case at a time since the elastic modulus of the tank material depended on the particular load case under test.

Such methods made optimization of a component difficult and time consuming because optimizing the component for one load case may not improve the performance of the component in another load case. In some instances, the optimization of the component for one load case may even decrease the performance of the component when the component is subjected to another load case.

The methods and systems described herein provide for an optimization solution of a component design with multiple load cases that does not change the elastic modulus of the component material. The methods and systems may be applied to optimizing for linear and nonlinear load cases including plastic strain, nonlinear displacement, and other linear responses such as, for example, vibration and stiffness. The methods and systems are applied in the fabrication machine components that meet or exceed the targets for each of the load cases associated with the machine components.

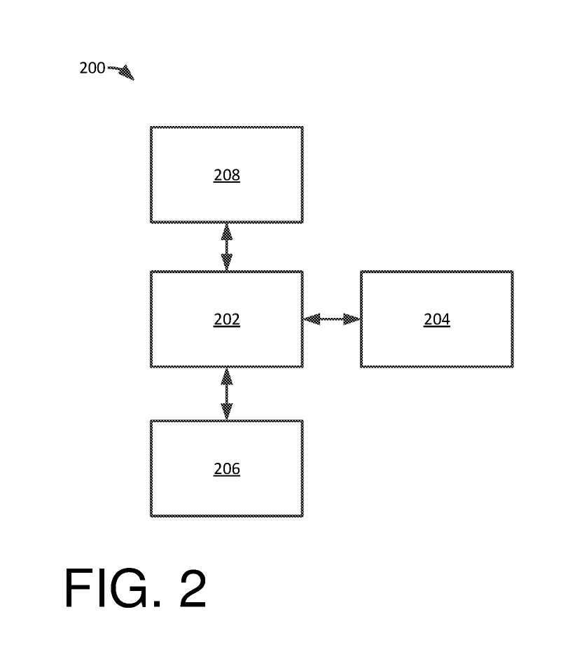

FIG. 2 illustrates a processing system 200 that includes a processor 202 that is communicatively connected to a memory 204, a display 206, and an input device 208.

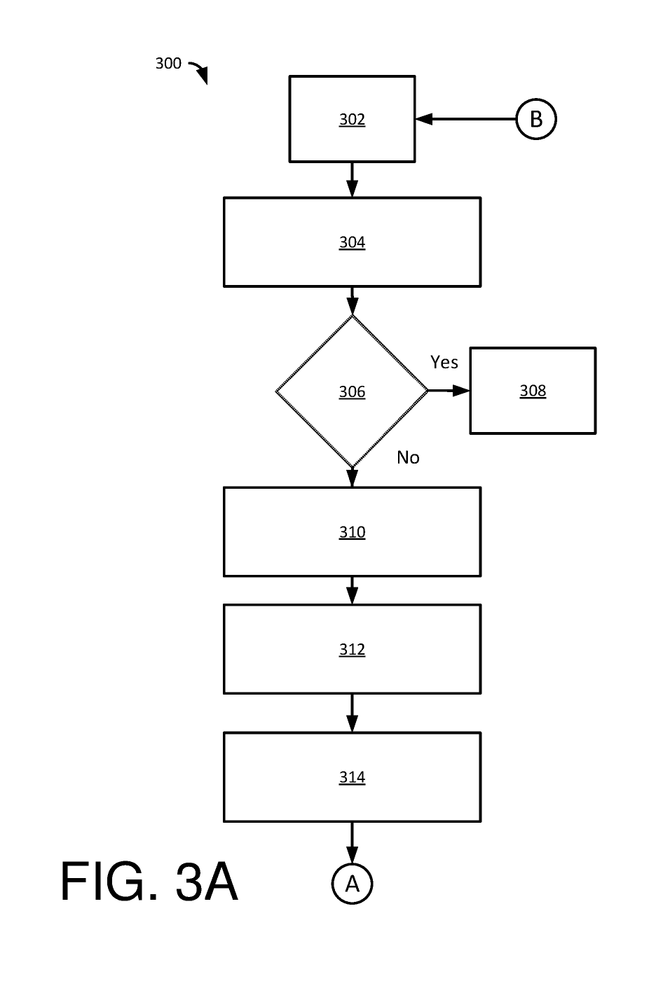

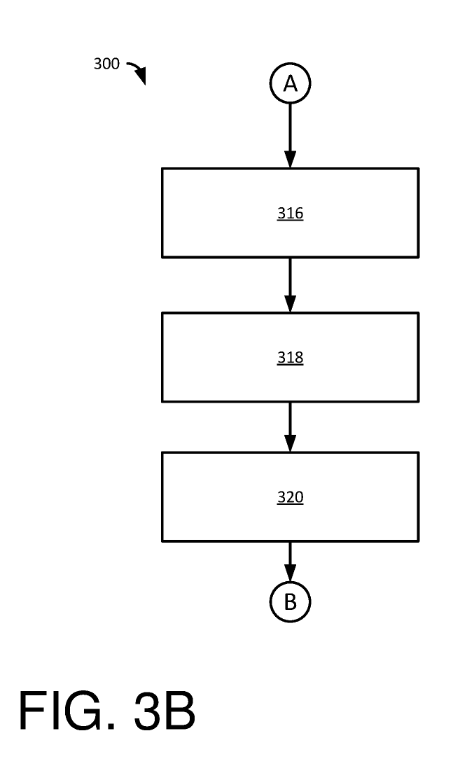

FIGS. 3A and 3B illustrate a block diagram of a method 300 for designing and fabricating a component of a machine such as, for example, the component 100 (of FIG. 1). The method 300 may be performed by the system 200 (of FIG. 2).

Referring to FIG. 3A, in block 302 the component design is received. The component design may include, for example, a data file that represents the design such as a computer aided design (CAD) file or other similar data.

In block 304, a nonlinear model such as, for example a Dyna model is run on the system 200. The nonlinear model calculates displacement values (X_{Nonlinear}^{m,L,i}) and plastic strain values (ε_{Nonlinear}^{m,L,i}), where m is the number of operation iterations, L is a load case identifier, and i is an element identifier.

In block 306, the system 200 determines whether the plastic strain values meet the target values (ε_{Nonlinear}^{T,L,i}), where T is a target. If yes, the component 100 may be fabricated in block 308. The component 100 may be fabricated using any suitable method or combination of methods such as, for example, injection molding, stamping, bending, forging, casting, brazing, or welding to fabricate the machine components.

If no, in block 310, a linear optimization model, for example, a Genesis model is run where the linear displacement (X_{Linear}^{m,L}) is equal to the nonlinear displacement for each load case (X_{Linear}^{m,L}=X_{Nonlinear}^{m,L}).

The forces (f_{Linear}^{m,L}) for each load case are calculated in block 312. Where (f_{Linear}^{m,L}=K_{Linear}^{m,L}X_{Linear}^{m,L}) and K_{Linear}^{m} is a stiffness matrix.

In block 314, a linear analysis is run to solve for the elastic strain (ε_{Linear}^{m,L,i}) for each element i and for each load case L.

Referring to FIG. 3B, in block 316, the processor calculates a linear strain target (ε_{Linear}^{T,L,i}) for each element i, where

$$\frac{{ɛ}_{Linear}^{T , L , i}}{{ɛ}_{Linear}^{m , L , i}} = F ( \frac{{ɛ}_{Nonlinear}^{T , L , i}}{{ɛ}_{Nonlinear}^{m , L , i}} ) .$$

The function F may be expressed as the sum of power terms multiplied by coefficients, where

$$F ( \frac{{ɛ}_{Nonlinear}^{T , L , i}}{{ɛ}_{Nonlinear}^{m , L , i}} ) = {a ( \frac{{ɛ}_{Nonlinear}^{T , L , i}}{{ɛ}_{Nonlinear}^{m , L , i}} )}^{0.5} + {b ( \frac{{ɛ}_{Nonlinear}^{T , L , i}}{{ɛ}_{Nonlinear}^{m , L , i}} )}^{1.0} + {c ( \frac{{ɛ}_{Nonlinear}^{T , L , i}}{{ɛ}_{Nonlinear}^{m , L , i}} )}^{2.0} + {d ( \frac{{ɛ}_{Nonlinear}^{T , L , i}}{{ɛ}_{Nonlinear}^{m , L , i}} )}^{3.0} + …$$

When the nonlinear target strain is met, the linear strain should also meet the linear target strain.

A parametric analysis determines that the best terms are the power of 1.0 and 2.0, thus for defining the linear strain the following equation may be used:

$$F ( \frac{{ɛ}_{Nonlinear}^{T , L , i}}{{ɛ}_{Nonlinear}^{m , L , i}} ) = {b ( \frac{{ɛ}_{Nonlinear}^{T , L , i}}{{ɛ}_{Nonlinear}^{m , L , i}} )}^{1.0} + ( 1 - b ) {( \frac{{ɛ}_{Nonlinear}^{T , L , i}}{{ɛ}_{Nonlinear}^{m , L , i}} )}^{2.0}$$

In block 318, the optimization problem to minimize mass is solved using the calculated linear strain target of block 316 where (ε_{Linear}^{m,L,i})≤(ε_{Linear}^{T,L,i}) for each load case and each element.

In block 320, the updated component design is output to a user on the display 206 (of FIG. 2). The updated component design may be received in block 302 for additional testing and optimization.

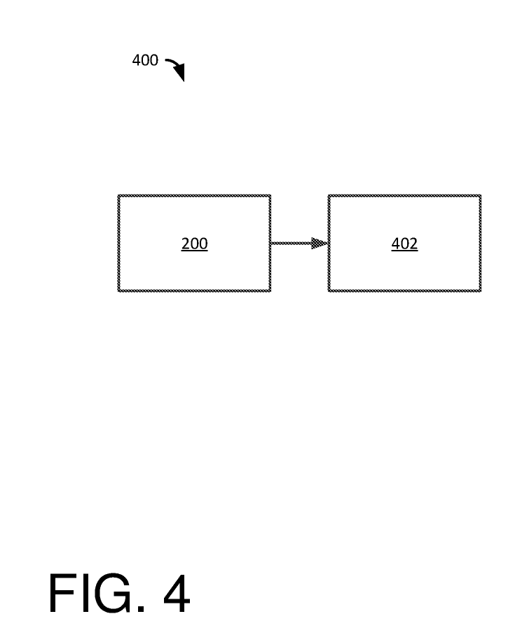

FIG. 4 illustrates a block diagram of a fabrication system 400. The system 400 includes the processing system 200 (of FIG. 2) that outputs the updated component design which includes instructions for fabrication tools 402 to fabricate the designed component.

The fabrication tools 402 may include any suitable fabrication tools or machines including, for example, injection molding machines and tooling, machine tooling fabrication tools, stamping machines, bending machines, welding machines, forging, and casting machines. Such fabrication tools 402 are used to fabricate the component 100 (of FIG. 1).

The methods and systems described herein provide for an optimization solution of a component design with multiple load cases that does not change the elastic modulus of the component material. The methods and systems may be applied to optimizing for linear and nonlinear load cases including plastic strain, nonlinear displacement, and other linear responses such as, for example, vibration and stiffness. The methods and systems are applied in the fabrication of machine components that meet or exceed the targets for each of the load cases associated with the machine components.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the application not be limited to the particular embodiments disclosed, but will include all embodiments falling within the scope of the application.

What is claimed is:

1. A method for fabricating a component, the method comprising:
receiving a first component design;
calculating a plastic strain for a load case;
determining whether the plastic strain meets a target plastic strain for the load case; and
responsive to determining that the plastic strain does not meet the target plastic strain for the load case:
calculating an elastic strain for the load case;
defining a linear strain target as a function of the plastic strain, the target plastic strain, and the elastic strain;
optimizing for a minimum mass of the component where a linear strain is less than the linear strain target; and
outputting a second component design.

2. The method of claim 1, further comprising fabricating the component according to the first component design responsive to determining that the plastic strain meets the target plastic strain for the load case.

3. The method of claim 1, further comprising
receiving the second component design;
calculating a second plastic strain for a load case;
determining whether the second plastic strain meets a target plastic strain for the load case; and
fabricating the component according to the second component design responsive to determining that the second plastic strain meets the target plastic strain for the load case.

4. The method of claim 1, wherein the calculating the plastic strain for the load case includes running a nonlinear model to calculate a nonlinear displacement and the plastic strain.

5. The method of claim 1, further comprising:
running a linear model where a linear displacement is equal to a nonlinear displacement;
calculating forces applied in the load case where the forces are a product of a stiffness matrix and the linear displacement; and
calculating the elastic strain.

6. The method of claim 1, wherein the elastic strain is calculated using a linear analysis.

7. The method of claim 1, wherein the first component design is a design for a fuel tank component.

8. The method of claim 2, wherein the component includes a fuel tank.

9. A system for fabricating a component, the system comprising:
a processor operative to:
receive a first component design;
calculate a plastic strain for a load case;
determine whether the plastic strain meets a target plastic strain for the load case; and
responsive to determining that the plastic strain does not meet the target plastic strain for the load case:
calculate an elastic strain for the load case;
define a linear strain target as a function of the plastic strain, the target plastic strain, and the elastic strain;
optimize for a minimum mass of the component where a linear strain is less than the linear strain target; and
output a second component design.

10. The system of claim 9, further comprising a fabrication tool operative to fabricate the component according to the first component design responsive to the processor determining that the plastic strain meets the target plastic strain for the load case.

11. The system of claim 9, wherein the processor is further operative to:
receive the second component design;
calculate a second plastic strain for a load case;
determine whether the second plastic strain meets a target plastic strain for the load case; and
fabricate the component according to the second component design responsive to determining that the second plastic strain meets the target plastic strain for the load case.

12. The system of claim 9, wherein the calculating the plastic strain for the load case includes running a nonlinear model to calculate a nonlinear displacement and the plastic strain.

13. The system of claim 9, wherein the processor is further operative to:
run a linear model where a linear displacement is equal to a nonlinear displacement;
calculate forces applied in the load case where the forces are a product of a stiffness matrix and the linear displacement; and
calculate the elastic strain.

14. The system of claim 9, wherein the elastic strain is calculated using a linear analysis.

15. The system of claim 9, wherein the first component design is a design for a fuel tank component.

16. The system of claim 10, wherein the component includes a fuel tank.
